(19) United States
(12) Patent Application Publication
(10) Pub. No.: US 2002/0063691 A1
(43) Pub. Date: May 30, 2002

(54) LCD and active web icon download

(76) Inventors: Rich Rogers, Houston, TX (US); David Vantrease, Spring, TX (US)

Correspondence Address: Robert A. Van Someren, Fletcher, Yoder & Van Someren, P.O. Box 692289, Houston, TX, 77269-2289, US

(21) Appl. No.: 09/727,972

(22) Filed: Nov. 30, 2000

(51) Int. Cl. G09G 5/00

(52) U.S. Cl. 345/168

(57) ABSTRACT

A method and apparatus for displaying icons on a user-configurable keyboard. Specifically, icons corresponding to software applications or uniform resource locators (URLs) are selected from a computer system monitor. The icons are transmitted to the key board and displayed in a display window, such as a liquid crystal display (LCD). Each icon displayed in the LCD on the keyboard has a corresponding launch key. When a launch key is depressed, the application or URL corresponding to that launch key will be opened.

### BACKGROUND OF THE INVENTION

1. Field Of The Invention

This invention relates generally to a computer system and, more specifically, to a user configurable keyboard comprising a plurality of icons for launching computer applications and URLs.

2. Background Of The Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Personal computer systems are made up of many components including processors, storage devices, input/output (I/O) devices, and networking devices. During system operation, a central processing unit (CPU) may load a set of instructions, such as a software program, from a hard disk drive or other secondary storage device, into primary storage, such as random access memory (RAM), where the CPU may begin executing the program. Word processors, spreadsheets, web browsers, and video games are examples of software which may be executed in this fashion.

I/O devices may provide external data to programs as input or they provide internal data to users as output. For example, word processors may use characters as input, while video games may use movement as input. Once the processor receives input, it performs computations based upon that input and reports the results as output. Thus, I/O devices allow users to interact with programs. Although there are many types of I/O devices, most personal computers have display monitors, keyboards, and pointing devices such as mice. A user can provide input by typing on a keyboard, pointing and clicking with a mouse, or speaking into a microphone for instance, and obtain output by viewing the display monitor or a printout.

Standard keyboards contain an array of keys which are accessible by finger and thumb movements, without moving the hands from a central location. Generally, when a key is pressed, the keyboard sends a specific electrical signal, representing the corresponding character, to the processor. The processor receives and translates this signal so that a program may use it as input. In addition to the character keys, standard keyboards contain function keys, typically labeled “F1” through “F12.” The function keys differ from the character keys in that they are usually not associated with specific characters or symbols. Typically, programs assign special functionality to these keys so that the programs perform specific tasks when the function keys are pressed. For example, a program may launch a help window when “F1” is pressed, or exit an application program when “F10” is pressed. Function keys may also be used by one application program to launch another application.

I/O devices often work together. For example, a pointing device, such as a mouse, controls a screen display pointer. The pointer moves across a display monitor according to corresponding movements of the mouse enabling a user to select executable programs or place a cursor in a desired location. A mouse typically has buttons which send signals to the processor when the buttons are clicked.

Icons may also appear on the display monitor and represent executable programs that launch when activated by the user. The icons are accessible by a keyboard or mouse. For instance, an icon may be associated with a particular word processing program. To launch the program, the user may place the pointer upon the icon and click the mouse.

Icons may also be used to represent uniform resource locators (UJRLs). URLs serve as links between interconnected computers, and when activated, they allow one computer to access another. Once computers are connected to a common network such as the Internet, they may exchange data, programs, or other stored information. For example, a user connected to the Internet may click on a URL to access a remote “website.”

Applications and URLs may be easily activated, by combining the functionality of various I/O devices. Current systems offer user configurable keyboard function keys for launching specified applications. A user can launch an application program by pressing a function key instead of selecting it from a menu bar or clicking on an icon. These systems configure function keys by linking a particular application to a specified function key. Because the system only works for a predetermined set of applications, an application not in this predetermined set must be launched in the conventional manner. Once the system is configured, templates may be placed over the function keys to remind users of the configuration. Each time the user adds new applications or reconfigures the system, a new template must be produced to reflect the changes. Present systems cannot activate URLs via the function keys. What is needed is a method and apparatus that allows users to launch applications and URLs using user-configurable icons, which may be displayed on a keyboard.

### SUMMARY OF THE INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In accordance with one aspect of the present invention, there is provided a user-configurable keyboard including a display, configurable to display a plurality of icons, and a plurality of keys corresponding to the plurality of icons and configurable to launch a software application or a Uniform Resource Locator corresponding to a respective icon.

In accordance with another aspect of the present invention, there is provided a computer system including a console comprising a central processing unit configurable to execute software routines, a monitor electrically coupled to the console and configurable to display icons corresponding to software applications or universal resource locators, and a keyboard electrically coupled to the monitor or the console. The keyboard includes a display configurable to display a plurality of icons, and a plurality of keys corresponding to the plurality of icons and configurable to launch a software application or a Uniform Resource Locator corresponding to a respective icon.

In accordance with still another aspect of the present invention, there is provided a method of configuring a keyboard comprising the steps of: selecting an icon from a system monitor, the icon corresponding to a software application or a universal resource locator; transmitting the icon from the monitor to a keyboard; and displaying the icon on the keyboard.

In accordance with yet another aspect of the present invention, there is provided a method of launching a software application or a universal resource locator comprising the steps of: selecting an icon from a system monitor, the icon corresponding to a software application or a universal resource locator; transmitting the icon from the monitor to a keyboard; displaying the icon on the keyboard; and depressing a key on the keyboard corresponding to the icon.

### BRIEF DESCRIPTION OF THE DRAWINGS

The foregoing and other advantages of the invention will become apparent upon reading the following detailed description and upon reference to the drawings in which:

FIG. 1 illustrates an exemplary computer system;

FIG. 2 illustrates a more detailed embodiment of the computer system illustrated in FIG. 1;

FIG. 3 illustrates a keyboard configured in accordance with one embodiment of the present invention;

FIG. 4 illustrates one embodiment of launch keys in accordance with the present invention;

FIG. 5 illustrates an exemplary system display in accordance with the present invention; and

FIG. 6 illustrates a block diagram of the process flow in accordance with the present technique.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

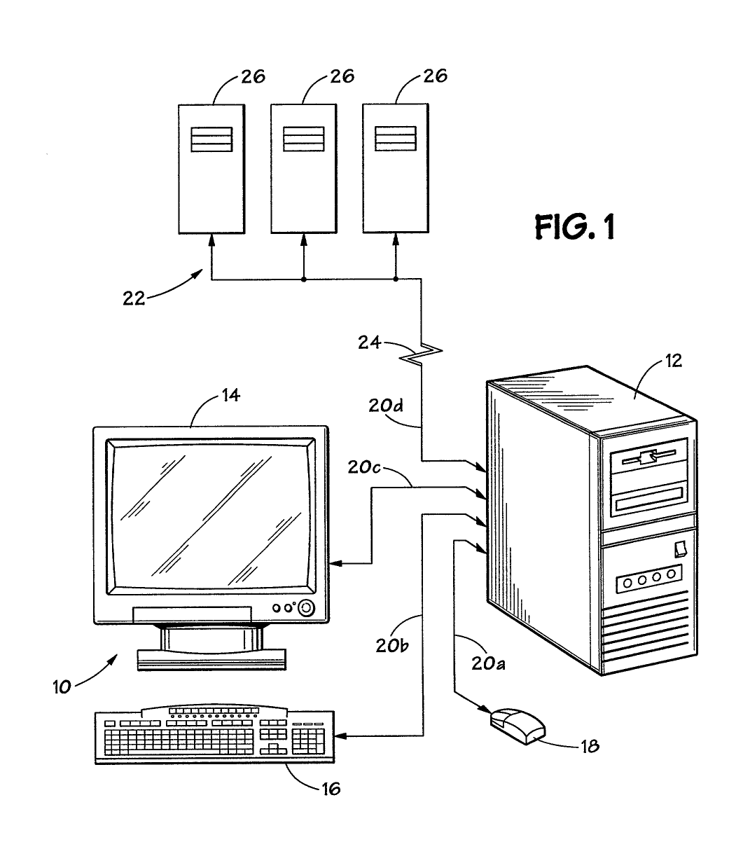

Turning now to the drawings, and referring first to FIG. 1, an exemplary computer system 10 is illustrated in the form of a personal computer or workstation. The computer system 10 includes a console 12 which may house processing chips, memory cards, communication devices, interface elements, and other circuitry as described more fully below. The console 12 is coupled to a monitor 14 for displaying graphical information to a system user. A keyboard 16 is also coupled to the console 12 for inputting data and for selecting desired functions, including rapid access to a network. Additional input devices, such as a mouse 18, may be coupled to the console 12 to provide additional input capabilities. The components of the computer system 10 are interconnected by data cables 20 a-d which may be standard serial or parallel data transmission assemblies. In one embodiment, the data cable 20b, which is coupled between the console 12 and the keyboard 16, may be a Uniform Serial Bus (USB) cable. Alternatively, one or more of the components of the computer system 10 may be configured to transmit and receive data by means of infrared transceivers or various alternative data transmission techniques.

The computer system 10 is adapted for connection to a network, such as the Internet or an intranet, designated generally by reference number 22. In particular, the console 12 is coupled to a remote communications line 24, such as a conventional telephone cable. Upon execution of network access routines as described below, the computer system 10 is placed in communication with remote computer terminals or servers 26 comprising the network 22. While reference is made in the present description to communication with a network, particularly with the Internet via conventional telephone cables, it should be noted that various alternative configurations may be employed to exchange data between the computer system 10 and the network 22. Such alternative configurations may include digital subscriber lines, wireless communication media, and so forth.

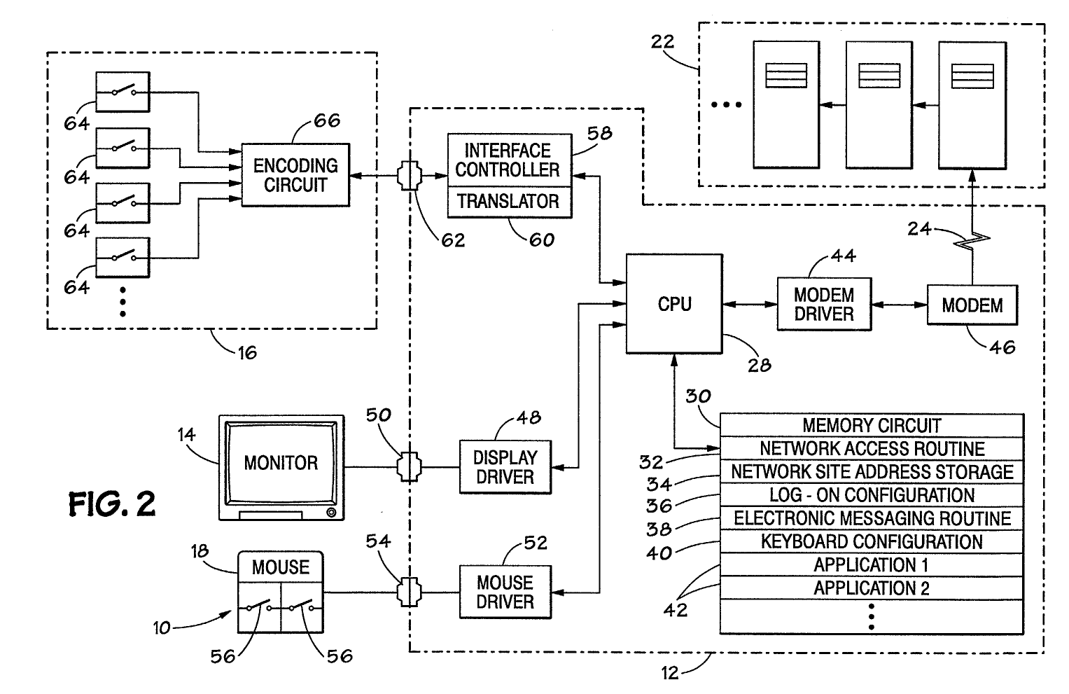

Functional circuitry components comprising the computer system 10 are illustrated in greater detail in FIG. 2. For the sake of clarity, elements similar to the elements previously described will be designated by like reference numerals. As shown in FIG. 2, the console 12 of the computer system 10 includes a CPU 28 configured to execute pre-established software routines stored in a memory circuit 30. The CPU 28 may be based on any suitable commercially available platform, such as the Pentium II processor available from Intel. Similarly, the memory circuit 30 may include various types and configurations of memory devices, such as random access memory (RAM), read only memory (ROM), dynamic random access memory (DRAM), and disk storage, including resident and removable disk drives. As represented diagramatically in FIG. 2, the memory circuit 30 includes a plurality of storage locations containing code for executing specific tasks. In particular, the memory circuit 30 advantageously stores a network or Internet access routine 32, a network site address configuration 34, a log-on configuration 36, electronic messaging routine and configuration 38, a keyboard configuration or map 40, and other application software routines 42. All of the routines stored in the memory circuit 30 are accessible by the CPU 28, and certain of these may include executable code for launching the application software.

The CPU 28 is also coupled to a series of driver and interface circuits for exchanging data with the peripheral devices included in the computer system 10. Specifically, in the illustrated embodiment, the CPU 28 is coupled to a modem driver 44 which commands operation of a modem 46. The modem 46 permits the CPU 28 to be coupled to the network 22, as described below. The CPU 28 is also coupled to a display driver 48 which transmits data to be displayed on the monitor 14 via a conventional communications port 50. A mouse driver 52 is coupled to the CPU 28 and permits input signals to be transmitted to the CPU 28 from the mouse 18 via a serial port 54. Such input signals originate in switches or sensors 56 provided in the mouse 18. While inputs from such sensors 56 may be processed in a conventional manner by the CPU 28, the mouse 18 may be configured to produce input signals for commanding the CPU 28 to execute specific software application code, including code which places the computer system 10 in communication with the network 22.

The CPU 28 is further operably coupled to a keyboard interface controller 58. The controller 58 commands operations of the keyboard 16 and coordinates communication of input signals from the keyboard 16 to the CPU 28, as described below. A translator 60 is provided for translating input signals in the form of scan code received from the keyboard 16, and for generating software interrupts as required by the scan code. The keyboard interface controller 58 and the translator 60 are coupled to the keyboard 16 through a communication port 62. The keyboard 16 includes an array of keys, as shown generally at reference numeral 64, for producing the input signals processed by the keyboard interface controller 58 and the translator 60. Upon actuation of the keys 64, unique scan code signals corresponding to the respective keys are produced by an encoding circuit 66. This scan code is then transmitted to the controller 58 and the translator 60 for processing prior to further transmission to the CPU 28. Advantageously, the keyboard 16 may be a Universal Serial Bus (USB) keyboard to permit rapid, generic, bi-directional communication between a user and the computer system 10.

In the embodiment illustrated in FIG. 2, certain of the functional circuitry may be defined by hardware, firmware, or software. For example, the drivers 44, 48, and 52 may be defined by appropriate code stored in the memory circuit 30. Similarly, the translator 60 may be defined by software code stored in the memory circuit 30. The encoding circuit 66 is preferably defined by firmware provided within the keyboard 16. As will be appreciated by those skilled in the art, however, the particular configuration and types of circuits performing the functions for placing the computer system in communication within a remote network, such as the Internet, may be accomplished in various manners. Accordingly, the encoding circuit 66 may be provided in the console 12 where desired.

Computer systems, such as the computer system 10, are often used to access software applications, such as Microsoft Word or Excel, or to access various websites and URLs through the Internet. Typically, an operator will use a mouse to position a pointer on a monitor. The pointer is positioned over an application icon or an icon designated to launch an Internet service provider such as Explorer or Netscape. By double-clicking the mouse while the pointer is positioned over an icon, the application corresponding, the application is launched. Alternatively, function keys on the keyboard may be configured to launch certain specific applications, as further discussed below.

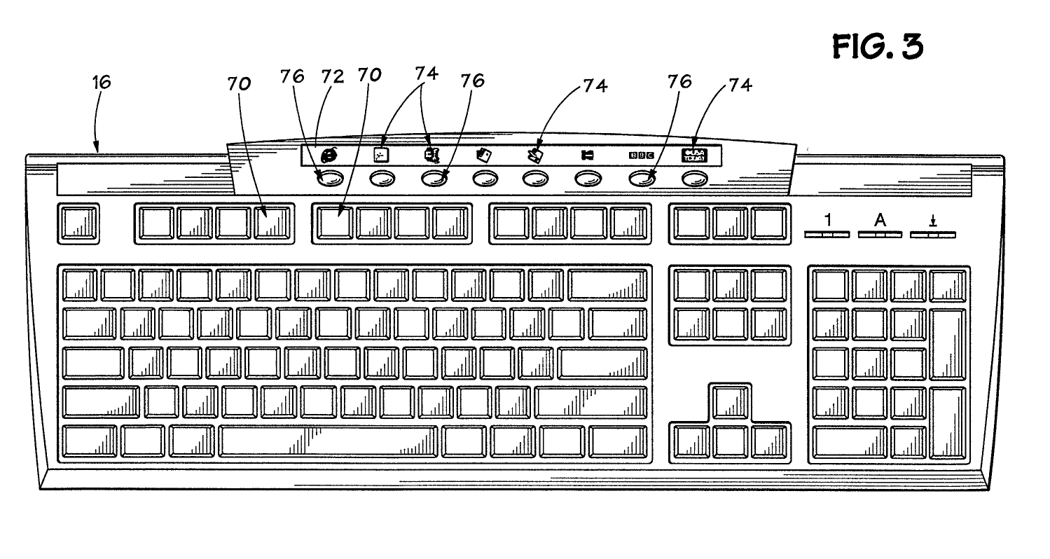

FIG. 3 illustrates an exemplary keyboard 16 in accordance with the present technique. Function keys 70 are provided for executing predetermined functions based upon particular software applications being run on a computer system. In addition to function keys 70, the keyboard 16 includes a display screen, such as a Liquid Crystal Display (LCD) 72, for displaying user configurable icons 74 proximate to a set of launch keys 76. While the exemplary display screen comprises LCD 72, it should be understood that the display screen may comprise any commercially available display medium. As summarized in greater detail below, the launch keys 76 may be user configurable allowing the user to program desired application program invocation or universal resource locator (URL) in the computer system memory circuitry. In an alternate embodiment, the display screen may comprise a touch screen such that the launch keys 76 are included on the surface of the display screen, here the LCD 72. Applications may then be launched by touching the LCD 72 at a location correlative to a desired icon 74. In another alternate embodiment, the function keys 70 may correspond to the icons 74 and may be used to launch a corresponding application or URL.

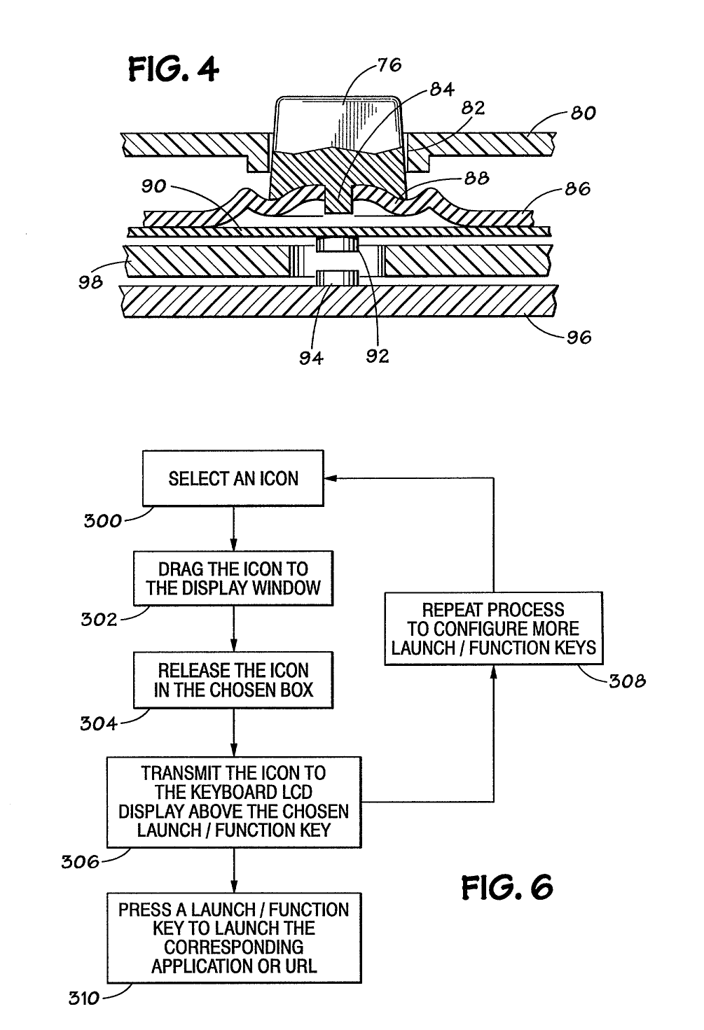

As illustrated in FIG. 4, in the present embodiment, launch keys 76 are pressed by the user to force contact of a membrane switch. The primary components of such a switch are illustrated in FIG. 4. Accordingly, the membrane switch 78 is formed below an upper panel 80 of the keyboard 16 (shown in FIG. 3). An aperture 82 is formed at each location in the keyboard 16 corresponding to the location of the launch key 76. Along a lower region, each key includes a protrusion 84 which extends through a resilient panel 86. The panel 86 forms a biasing region 88 below each launch key 76 to bias the key into an upward position. A membrane 90 is positioned below the resilient panel 86, and carries a plurality of contacts 92. Each contact 92 is coupled to a conductor in a conductor grid for transmitting signals to an encoding circuit 66 (shown in FIG. 2). A lower contact 94 is positioned in mutually facing relation to contact 92. Contact 94 may rest on a base plate 96. Like contact 92, contact 94 is coupled to a conductor (not shown) on a grid for transmitting signals to an encoding circuit upon closure of the switch. An insulated separator 98 is positioned between the membrane 90 and the plate 96. Upon depression of the key 76, the protrusion 84 forces contact 92 downwardly toward contact 94, thereby completing a conductive path through the switch. Alternatively, switches may be foreseen in the keyboard for executing the rapid launch functions described below. Such switches may include, for example, capacitive switches. Moreover, touch screen techniques may also be used to send signals from the keyboard LCD 72, allowing the user to touch the LCD 72 directly, instead of pressing the launch keys 76 or function keys 70.

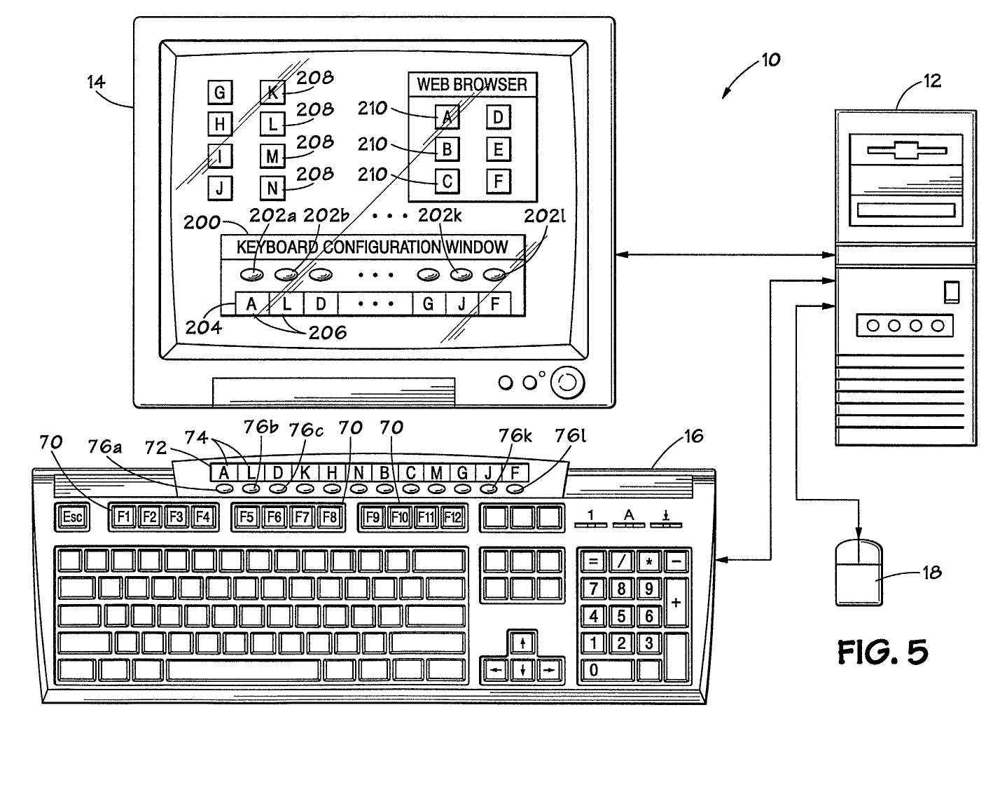

Software stored in the computer system memory circuit may allow the user to configure the function keys to launch specific applications or navigate to specific Internet sites. An exemplary system display is illustrated in FIG. 5. Specifically, the computer system 10 is illustrated, including the console 12 the monitor 14, the keyboard 16, and the mouse 18. The configuration software may produce a keyboard configuration window 200 which displays a graphical representation of keyboard launch keys 202a-l and the LCD window 204 which displays icons 206 corresponding to selected applications and URLS, allowing user interaction with a pointing device, such as a mouse. The elements displayed in the keyboard configuration window 200 correlate with certain elements (LCD 72, icons 74 and launch keys 76) on the keyboard 16. By dragging and dropping icons with a mouse 18, users may configure the keyboard launch keys 76. A user may set a keyboard launch key to launch a specified application by dragging an application icon 208, corresponding to a software application such as Microsoft Word, to a function key on the keyboard configuration window 200. Alternatively, a user can select a web-based icon 210, corresponding to a particular URL, from a website. Once the icon is placed with a designated graphical launch key 202a-l, the icon then appears on a keyboard LCD 72 positioned above a corresponding keyboard launch key 76a-l. The user may then launch the designated application by pressing the particular keyboard launch key, instead of choosing it from an on-screen menu bar. Also, the function keys 70 may similarly be configured to launch applications displayed on the LCD 72. Alternatively, if the keyboard display is a touch-screen display, applications may be configured for rapid invocation in a similar drag and drop manner, and they may be launched by touching the keyboard display where the application icon appears. Advantageously, the keyboard 16 now displays icons on the user-configurable LCD window 210. A user is able to select a corresponding function key to launch a particular application without using a mouse or a monitor. Further, a user does not need to remember the applications associated with each function key since the application icons are displayed on the keyboard 16.

In the example illustrated in FIG. 5, web-based icon A has been dragged from a web-site and dropped into the keyboard configuration windows 200 at the position corresponding to the first launch key 76a. Similarly, other icons have been dragged and positioned corresponding to the remaining launch keys 76b-l. As illustrated, the icons appearing in the keyboard configuration window 200 are transmitted to their corresponding location on the keyboard LCD 72.

The process flow corresponding to the embodiment discussed with reference to FIG. 5 is illustrated in FIG. 6. First, an icon corresponding to an application or URL is selected from a web browser or operating system using a mouse, as in block 300. Next, the mouse 18 is used to drag the icon to a configuration window 200 on the monitor 14, which correlates with the configuration of the launch keys 76a-l on the keyboard 16, as in block 302. The icon is then released in a location in the keyboard configuration window 200 such as corresponding to location 202a correlating with a specific launch key (such as launch key 76a), as in block 304. The icon is then transmitted to the keyboard 14 and displayed on an LCD display 72 corresponding to the specific launch key 76a, as in block 306. The process may be repeated to configure other launch keys 76b-l, as in block 308. Once the icon is displayed on the LCD display 72 on the keyboard 14, the application or URL can be launched by depressing the corresponding launch key 76a-l, as in block 310.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling with the spirit and scope of the invention as defined by the following appended claims. For example, while in the foregoing description reference has been made to a general purpose keyboard having dedicated keys for rapid access to the Internet sites configured in the computer system, various alternative forms of input devices may be envisaged. Such keys may be provided in a mouse or similar peripheral input devices. Similarly, keys for performing these functions may be provided in a remote input device, such as a hand-held radio frequency or infrared controller. Also, where desired, sensitive regions may be provided in a terminal screen for permitting a user to generate Internet access signals for addressing specific Internet sites upon touching pre-established locations on the screen.

What is claimed is:

1. A user-configurable keyboard comprising:
a display configurable to display a plurality of icons; and
a plurality of keys corresponding to the plurality of icons and configurable to launch one of a software program and a Uniform Resource Loctator corresponding to a respective icon.

2. The keyboard, as set forth in claim 1, wherein the display comprises a liquid crystal display.

3. The keyboard, as set forth in claim 1, wherein the keys comprise function keys.

4. The keyboard, as set forth in claim 1, wherein the display comprises a single window having a plurality of icons.

5. The keyboard, as set forth in claim 1, wherein the display comprises a plurality of windows, each window having at least one icon.

6. A computer system comprising:
a console comprising a central processing unit configurable to execute software routines;
a monitor electrically coupled to the console and configurable to display icons corresponding to one of a plurality of software applications and a plurality of uniform resource locators; and
a keyboard electrically coupled to at least one of the monitor and the console, the keyboard comprising:
a display configurable to display a plurality of icons; and
a plurality of keys corresponding to the plurality of icons and configurable to launch one of a software program and a Uniform Resource Loctator corresponding to a respective icon.

7. The system, as set forth in claim 6, wherein the console is coupled to a network.

8. The system, as set forth in claim 6, wherein the console is coupled to the Internet.

9. The system, as set forth in claim 6, comprising a mouse.

10. The system, as set forth in claim 6, wherein the keyboard is electrically coupled to the console through a universal serial bus cable.

11. The system, as set forth in claim 6, wherein the display of the keyboard comprises a liquid crystal display.

12. The system, as set forth in claim 6, wherein the keys on the keyboard are function keys.

13. The system, as set forth in claim 6, wherein the display comprises a single window having a plurality of icons.

14. The keyboard, as set forth in claim 6, wherein the display comprises a plurality of windows, each window having at least one icon.

15. A method of configuring a keyboard comprising the acts of:
(a) selecting an icon from a system monitor, the icon corresponding to one of a software application and a uniform resource locator;
(b) transmitting the icon from the monitor to a keyboard; and
(c) displaying the icon on the keyboard.

16. The method, as set forth in claim 15, wherein act (a) comprises the step of selecting an icon from a website.

17. The method, as set forth in claim 15, wherein act (a) comprises the step of selecting an icon from an operating system window.

18. The method, as set forth in claim 15, wherein act (a) comprises the step of selecting an icon using a mouse.

19. The method, as set forth in claim 15, wherein act (a) comprises placing the icon in a predetermined location on a system monitor.

20. The method, as set forth in claim 19, wherein act (a) comprises the step of placing the icon in a keyboard configuration window on the system monitor.

21. The method, as set forth in claim 15, wherein act (b) comprises the step of transmitting the icon from the monitor to a keyboard using a universal serial bus cable.

22. The method, as set forth in claim 15, wherein act (c) comprises the step of displaying the icon on a liquid crystal display.

23. A method of launching one of a software application and a uniform resource locator comprising the acts of:
(a) selecting an icon from a system monitor, the icon corresponding to one of a software application and a uniform resource locator;
(b) transmitting the icon from the monitor to a keyboard;
(c) displaying the icon on the keyboard; and
(d) depressing a key on the keyboard corresponding to the icon.

24. The method, as set forth in claim 23, wherein act (a) comprises the act of selecting an icon from a web site.

25. The method, as set forth in claim 23, wherein act (a) comprises the act of selecting an icon from an operating system window.

26. The method, as set forth in claim 23, wherein act (a) comprises the act of selecting an icon using a mouse.

27. The method, as set forth in claim 23, wherein act (a) comprises the act of placing the icon in a predetermined location on a system monitor.

28. The method, as set forth in claim 27, wherein act (a) comprises the act of placing the icon in a keyboard configuration window on the system monitor.

29. The method, as set forth in claim 23, wherein act (b) comprises the act of transmitting the icon from the monitor to a keyboard using a universal serial bus cable.

30. The method, as set forth in claim 23, wherein act (c) comprises the step of displaying the icon on a liquid crystal display.

31. The method, as set forth in claim 23, wherein act (d) comprises the step of depressing a function key on the keyboard.

32. The method, as set forth in claim 23, wherein act (d) comprises launching one of a software application and a Uniform Resource Locator corresponding to the icon corresponding to the depressed key.
